(19) United States
(12) Patent Application Publication
(10) Pub. No.: US 2013/0236803 A1
(43) Pub. Date: Sep. 12, 2013

(54) FUEL CELL MODULE

(71) Applicants: Norishige Konno, Toyota-shi (JP); Takashi Kajiwara, Gotenba-shi (JP); Masayuki Ito, Susono-shi (JP); Hitoshi Hamada, Gotenba-shi (JP); Haruyuki Aono, Susono-shi (JP); Tomoyuki Takamura, Toyota-shi (JP)

(72) Inventors: Norishige Konno, Toyota-shi (JP); Takashi Kajiwara, Gotenba-shi (JP); Masayuki Ito, Susono-shi (JP); Hitoshi Hamada, Gotenba-shi (JP); Haruyuki Aono, Susono-shi (JP); Tomoyuki Takamura, Toyota-shi (JP)

(73) Assignee: TOYOTA JIDOSHA KABUSHIKI KAISHA, Toyota-shi, Aichi-ken (JP)

(21) Appl. No.: 13/202,925

(22) PCT Filed: Dec. 2, 2010
(86) PCT No.: PCT/JP10/71567

§ 371 Date: Aug. 23, 2011

(51) Int. Cl. H01M 8/02

(52) U.S. Cl. CPC H01M 8/0271
USPC 429/434; 429/452; 429/456

(57) ABSTRACT

A fuel cell module which is capable of easily securing an adequate sealing function even when the unit cell is made thinner. The fuel cell module includes a stacked body which includes: a stacked structure including: an electrolyte layer, and a pair of electrodes provided to sandwich the electrolyte layer; and a pair of separators disposed to sandwich the stacked structure, the separators being arranged at least one end of the stacked body in the stacking direction, the separators which are arranged at the end of the stacked body having a groove which is capable of receiving a sealing member in a face which does not oppose to the stacked structure, and the at least one groove being a deep groove of which depth is larger than the thickness of the separator having the groove.

### TECHNICAL FIELD

The present invention relates to a fuel cell module having a plurality of fuel cells.

### BACKGROUND ART

A fuel cell is an apparatus which comprises a stacked structure comprising an electrolyte and a set of electrodes (anode and cathode) disposed in a manner to sandwich the electrolyte and which takes out the electrical energy generated in the stacked structure through a current collector (for example, separator) arranged outside the stacked structure. Among various fuel cells, solid polymer electrolyte fuel cell (hereinafter, referred to as “PEFC”.) used for domestic cogeneration system, automobiles, and so on can be operated in a low temperature region. Because of its high energy conversion efficiency, short start-up time, and small-sized and lightweight system, the PEFC has received attention as a power source of electric vehicles or cellular phones.

A unit cell of the PEFC comprises: an membrane electrode assembly (MEA); and cathode and anode both at least comprising a catalyst layer. Its theoretical electromotive force is 1.23 V. In the PEFC, a hydrogen-containing gas is supplied to an anode and an oxygen-containing gas is supplied to a cathode. The hydrogen supplied to the anode separates into proton and electron on a catalyst contained in a catalyst layer of the anode (hereinafter, referred to as “anode catalyst layer”.). The proton generated from the hydrogen reaches a catalyst layer of the cathode (hereinafter, referred to as “cathode catalyst layer”.) through the anode catalyst layer and the electrolyte membrane. On the other hand, the electron reaches the cathode catalyst layer through an external circuit; with this process, it is possible to take electrical energy out. Then, when the proton and electron respectively having reached the cathode catalyst layer react with the oxygen to be supplied to the cathode catalyst layer, water is produced.

As techniques related to such a fuel cell, for example, Patent document 1 discloses a fuel cell module, in which a plurality of fuel cells are stacked; gaskets are integrally formed at the peripheral edges of the stacked membrane electrode assemblies and porous bodies, to form a single module comprising a plurality of the fuel cells; and a plurality of stacked bodies are assembled. In the Patent document 1, the fuel cell is provided with a plurality of manifolds, separators are respectively disposed at both ends of the stacked body, and an endless first sealing member (i.e. O-ring) surrounding the manifold intervenes between separators of adjacent stacked bodies. In addition, Patent document 1 also discloses an embodiment where an endless groove is formed at a position around the manifold of opposing face of separators of the adjacent stacked bodies so that the position of the groove in one separator corresponds to that of the groove in the other separator, wherein in the form where adjacent stacked bodies are assembled, a part of or all of the first sealing member is received in an endless space defined by both of the grooves corresponding to each other. Patent document 2 discloses a fuel cell at least comprising a pair of a first and a second electrolyte membrane-electrode assemblies disposed at both ends of the electrolyte; the fuel cell is provided with a plurality of generating unit formed of: a first metal separator, the first electrolyte membrane-electrode assembly, a second metal separator, the second electrolyte membrane-electrode assembly, and a third metal separator, laminated in the mentioned order, wherein passage for cooling medium is formed between the generating unit. Patent document 3 discloses a fuel cell comprising: a first separator and a second separator, wherein the first separator has a smaller outer diameter than the second separator and wherein the outer periphery of the second separator has fluid communication holes, which at least includes: a fuel gas entrance communication hole, a fuel gas exit communication hole, an oxidizer gas entrance communication hole and an oxidizer gas exit communication hole, respectively penetrating in the stacking direction at the position protruding outwardly from an outer-shape end of the first separator. Patent document 4 discloses a separator for compact fuel cell, which comprises: a gas inlet manifold; gas passages penetrating in a strip-like manner over the electrode area in a battery side face; gas grooves for inletting gas formed in the face opposite to the battery side face so as to connect the manifold to the gas passage; and O-ring groove formed so as to encircle the gas passage and the gas groove.

### CITATION LIST

### Patent Literature

Patent Document 1: Japanese Patent Application Laid-Open (JP-A) No. 2010-080222

Patent Document 2: JP-A No. 2009-043665

Patent Document 3: JP-A No. 2007-324108

Patent Document 4: JP-A No. 2002-056859

### DISCLOSURE OF THE INVENTION

### Problems to be Solved by the Invention

In the technique disclosed in Patent document 1, it is thought that when an inexpensive and easily exchangeable O-ring is used as the first sealing member, it is possible to improve, for example, working efficiency at a time of maintenance. In general, when the size and power of a fuel cell module is specified, the diameter of an O-ring for sealing fluid used in the fuel cell module is specified. Conventionally, in a case of using a separator of which thickness is larger than the depth of a recess portion for installing an O-ring having a required diameter, it is possible to adequately seal fluid by using an O-ring having an appropriate diameter and being installed in the groove formed in the separator. However, when using a thinner separator with the development of thin technology of unit cell, it is difficult to provide in a separator a groove which is capable of receiving an O-ring having an appropriate diameter. So, there is a potential difficulty to secure an adequate sealing function. Such a problem is difficult to be solved even by a combination of the technique disclosed in Patent document 1 and techniques of Patent documents 2 to 4.

Accordingly, an object of the present invention is to provide a fuel cell module which is capable of easily securing an adequate sealing function even when the unit cell is made thinner.

### Means for Solving the Problems

So as to solve the above problem, the present invention takes the following means. In other words, the invention is a fuel cell module comprising a stacked body which comprises: a stacked structure including: an electrolyte layer, and a pair of electrodes provided to sandwich the electrolyte layer; and a pair of separators disposed to sandwich the stacked structure, the separators being arranged at least one end of the stacked body in the stacking direction, the separators which are arranged at the end of the stacked body having a groove which is capable of receiving a sealing member in a face which does not oppose to the stacked structure, and the at least one groove being a deep groove of which depth is larger than the thickness of the separator having the groove.

Here, in the invention, when a porous body (for example, a gas diffusion layer) for letting a fluid passing therethrough is arranged between an electrode and a separator, the porous body is also the constituent element of the stacked structure. Moreover, in the invention, the term “stacking direction (of the stacked body)” means a direction along which elements constituting the stacked body such as electrolyte layer, electrodes, and separators are stacked; it can be expressed by “thickness direction of the separator”. The term “the separators which are arranged at the end of the stacked body” means at least one separator out of the separators disposed at both ends of the stacked body when the separators are respectively arranged at both ends of the stacked body in the stacking direction. On the other hand, when a separator is arranged at one end of the stacked body in the stacking direction and a constituent element other than the separator is arranged at the other end in the stacking direction, the term “the separators which are arranged at the end of the stacked body” means a separator arranged at one end of the stacked body in the stacking direction. In the invention, the term “face which does not oppose to the stacked structure” means the lower face (or the upper face) of a separator when the upper face (or the lower face) of the separator opposes to the stacked body. In the invention, the term “thickness of the separator having the groove” means a thickness of a separator at a position thereof opposing to the stacked structure in the stacking direction of the stacked body. In addition, the fuel cell module of the invention has a single stacked body or laminated two or more stacked bodies.

In the above invention, the height of a protrusion formed in a face, which does not have the deep groove, of the separator having the deep groove may be larger than the thickness of the stacked structure contacting the separator.

Here, for example, when the deep groove is provided at the upper face (or the lower face) of the separator, the term “a face, which does not have the deep groove, of the separator having the deep groove” means the lower face (or the upper face) of the separator. The term “a protrusion formed in a face, which does not have the deep groove, of the separator having the deep groove” means a protrusion formed in the lower face (or the upper face) of the separator by providing the deep groove in the upper face (or the lower face) of the separator.

In addition, in the invention where the height of the protrusion is larger than the thickness of the stacked structure contacting the separator, at least one of the separators which does not have the deep groove may have a recess portion which is capable of absorbing at least a part of the height of the protrusion.

Here, the phrase “at least one of the separators which does not have the deep groove has a recess portion which is capable of absorbing at least a part of the height of the protrusion” means that at least one of the separators which does not have the deep groove has a recess portion where the total thickness of a separator which does not have a recess portion and a separator which has a protrusion is thicker than the total thickness of two separators.

Moreover, in the above invention, the area of a face, of which normal direction is the stacking direction, of at least one of the separators which do not have the deep groove may be smaller than the separator having the deep groove, the smaller-sized separator and the separator having the deep groove may be arranged so that the outer periphery of the separator having the deep groove locates in the periphery of the smaller-sized separator, and the deep groove may be provided in the outer periphery of the separator having the deep groove located in the periphery of the smaller-sized separator.

Further, in the above invention, preferably, the separator having the deep groove has a fluid inlet passage penetrating therein, and the groove provided at the position having the fluid inlet passage is shallower than at least one of the grooves provided at the position which does not have the fluid inlet passage.

Here, the term “the groove provided at the position having the fluid inlet passage” means a groove of the separator, where the groove is provided at the upper side or the lower side of the fluid inlet passage when seeing a cutting plane (which defines the thickness direction of the separator as the vertical direction) at a position (where the fluid inlet passage locates) of the separator having a groove; namely, it is a groove provided in a manner to stride across the fluid inlet passage. In the invention, the groove and the fluid inlet passage are not communicated to each other.

Still further, in the above invention, preferably, a face, which does not oppose to the stacked structure, of the separator arranged at an end of the stacked body in the stacking direction comprises a passage for making a cooling medium or an oxygen-containing gas pass through and a groove which is capable of receiving a sealing member for preventing outflow of a cooling medium or an oxygen-containing gas passing through the passage, and the groove is provided in the outer periphery of the separator so that the groove encircles the passage, the manifold for the air to be supplied to the stacked structure, and the manifold for the cooling medium.

Here, the term “air to be supplied to the stacked body” means a hydrogen-containing gas and an oxygen-containing gas.

### Effects of the Invention

The fuel cell module of the present invention has separators having deep grooves. By a configuration with a separator having a deep groove, even when the unit cell is made thinner, it is possible to secure the deep groove formed with a depth necessary to receive a sealing member such as O-ring, gasket, and adhesive. By securing the deep groove with a depth necessary to receive the sealing member, it is possible to easily secure an adequate sealing function. Accordingly, with this invention, it is possible to provide a fuel cell module which is capable of easily securing an adequate sealing function even when the unit cell is made thinner.

In the invention, even in a case that the height of the protrusion formed in a face, which does not have the deep groove, of the separator having the deep groove is larger than the thickness of the stacked structure contacting the separator, by modifying a separator other than separator having the deep groove, even when the unit cell is made thinner, it is possible to provide a fuel cell module which is capable of securing an adequate sealing function easily.

Moreover, in the invention where the height of the protrusion is larger than the thickness of the stacked structure contacting the separator, when at least one of the separators which does not have the deep groove has a recess portion which is capable of absorbing at least a part of the height of the protrusion, it becomes easy to attain thinning of the unit cell while securing an adequate sealing function.

Further, in the invention, with a configuration where a deep groove is provided in the outer periphery of a separator having a deep groove located in the periphery of the smaller-sized separator, it becomes easy to attain thinning of the unit cell while securing an adequate sealing function.

Still further, in the invention, with a configuration where the groove provided at the position having the fluid inlet passage is shallower than at least one of the grooves provided at the position which does not have the fluid inlet passage, it is possible to effectively use the thickness of the separator; thereby it becomes easy to attain thinning of the unit cell while securing an adequate sealing function.

Still further, in the invention, with a configuration where a passage for making a cooling medium or an oxygen-containing gas pass through and a groove which is capable of receiving a sealing member for preventing outflow of a cooling medium or an oxygen-containing gas passing through the passage locate in a surface of the separator which does not oppose to the stacked structure and the groove is provided to encircle the passage, the manifold for the air to be supplied to the stacked structure, and the manifold for the cooling medium, in addition to the above effects, it is possible to reduce wasted space of the fuel cell module.

### BRIEF DESCRIPTION OF THE DRAWINGS

FIG. 1 is a cross-sectional view illustrating a fuel cell module 100;

FIG. 2 is a cross-sectional view illustrating the fuel cell module 100;

FIG. 3 is a cross-sectional view illustrating a stacked structure 5;

FIG. 4 is a top view of a separator 1;

FIG. 5 is a plan illustrating a mode of conventional sealing;

FIG. 6 is a cross-sectional view illustrating a stacked body 30;

FIG. 7 is a cross-sectional view illustrating the laminated stacked bodies 30, 30;

FIG. 8 is a top view of a separator 40;

FIG. 9 is a cross-sectional view of the separator 40; and

FIG. 10 is another cross-sectional view of the separator 40.

### BEST MODE FOR CARRYING OUT THE INVENTION

Hereinafter, the present invention will be described with reference to the drawings. It should be noted that the embodiments shown below are examples of the present invention, so that the invention is not limited by the embodiments. In order to make the understanding of the present invention easier, a part of the reference numerals in the drawings may not be shown.

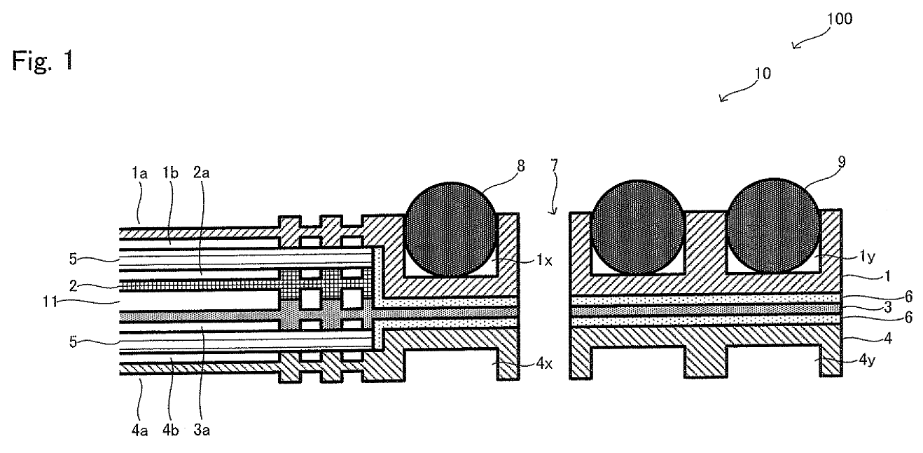

FIG. 1 is a cross-sectional view illustrating a fuel cell module 100. In FIG. 1, a part of the cross section of the fuel cell module 100 is shown. In FIG. 1, a hydrogen gas inlet passage connecting a hydrogen manifold 7 to hydrogen gas flow paths 1b, 3a, an air inlet passage connecting an air manifold (not shown) to air flow paths 2a, 4b, and a cooling medium inlet passage connecting a cooling medium manifold (not shown) to cooling medium passages 1a, 4a, 11 are not shown.

As shown in FIG. 1, the fuel cell module 100 comprises a stacked body 10 comprising: stacked structures 5, 5; separators 1, 2, 3, 4 disposed to sandwich the stacked structures 5, 5; a hole 7 which functions as a hydrogen manifold; an air manifold (not shown); and a cooling medium manifold. At both ends of the stacked body 10 in the stacking direction (i.e. the vertical direction of FIG. 1.), a separator 1 and a separator 4 are respectively arranged. Adhesives 6, 6 are arranged in the outer periphery of the stacked structures 5, 5; with the adhesives 6, 6, the outer periphery of the separators 1, 3, 4 and an end face of the separator 2 are fixed. The separator 1 has deep grooves 1x, 1y which are capable of receiving O-rings 8, 9 as a sealing member in a face which does not oppose to the stacked structure 5. Moreover, the separator 4 has deep grooves 4x, 4y which are capable of receiving O-rings 8, 9 as a sealing member in a face which does not oppose to the stacked structure 5. The fuel cell module 100 is used in a condition that the laminated a plurality of stacked bodies 10, 10, . . . are incorporated in a case (not shown).

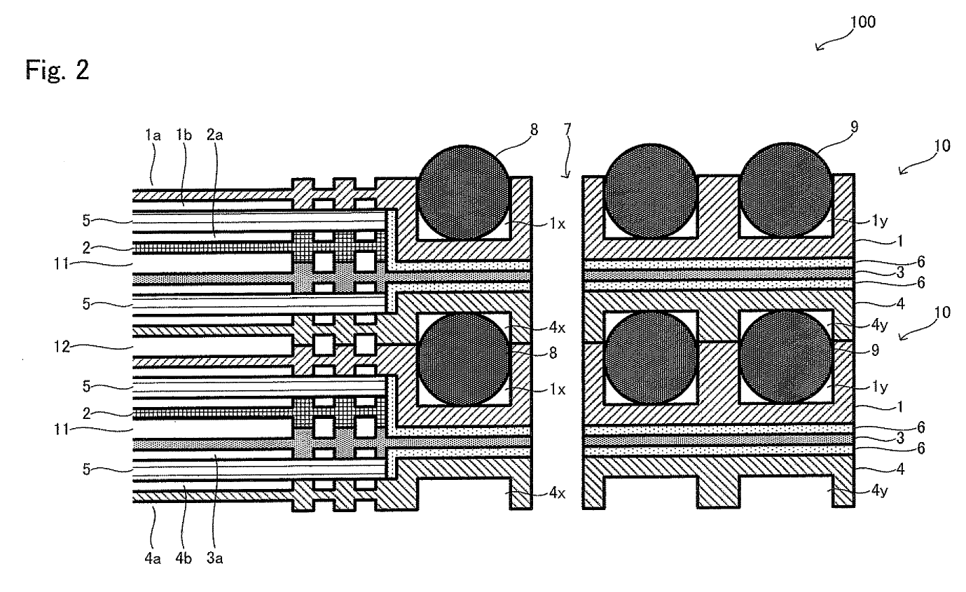

FIG. 2 is a cross-sectional view illustrating a condition that a plurality of the stacked bodies 10, 10 are laminated. In FIG. 2, a hydrogen gas inlet passage connecting the hydrogen manifold 7 to the hydrogen gas flow paths 1b, 3a, an air inlet passage connecting the air manifold (not shown) to the air flow paths 2a, 4b, and a cooling medium inlet passage connecting the cooling medium manifold (not shown) to the cooling medium passages 1a, 4a, 11, 12 are not shown. As shown in FIG. 2, when a plurality of the stacked bodies 10, 10 are laminated, the O-ring 8 is set in a space defined by the deep groove 1x and the deep groove 4x and the O-ring 9 is set in a space defined by the deep groove 1y and the deep groove 4y. So as to secure a predetermined sealing property, the total depth of the deep groove 1x and the deep groove 4x is smaller than the diameter of the O-ring 8; with the O-ring 8 thus set, leakage of hydrogen passing through the hydrogen manifold 7 can be prevented. In addition, so as to secure a predetermined sealing property, the total depth of the deep groove 1y and the deep groove 4y is smaller than the diameter of the O-ring 9; with the O-ring 9 thus set, leakage of cooling medium passing through the cooling medium passage 12 can be prevented.

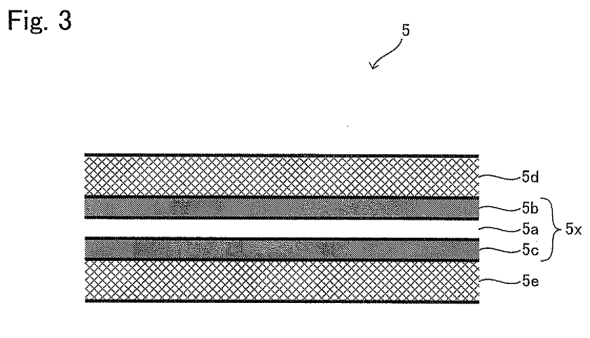

FIG. 3 is a cross-sectional view enlarging a part of the stacked structure 5. As shown in FIG. 3, the stacked structure 5 comprises: a solid polymer electrolyte membrane 5a (hereinafter, referred to simply as “electrolyte membrane 5a”.); an MEA 5x having an anode electrode 5b and a cathode electrode 5c disposed in a manner to sandwich the electrolyte membrane 5a; and a gas diffusion layer 5d and a gas diffusion layer 5e disposed in a manner to sandwich the MEA 5x. In the stacked structure 5, the gas diffusion layer 5d is disposed at the anode electrode 5b side; the gas diffusion layer 5e is disposed at the cathode electrode 5c side. The fuel cell module 100 will be described with reference to FIGS. 1 to 3. For example, a hydrogen gas which has been supplied to the stacked structure 5 through the hydrogen gas flow path 1b reaches the anode electrode 5b through the gas diffusion layer 5d. In the anode electrode 5b, a reaction expressed by the following formula (1); then protons and electrons are produced.

H₂→2H⁺+2e⁻ (1)

The protons produced in the anode electrode 5b reach the cathode electrode 5c through the electrolyte membrane 5a; while, since the electrolyte membrane 5a does not have electron conductivity, the electrons produced in the anode electrode 5b reach the cathode electrode 5c via the external circuit.

On the other hand, for example, the air which has been supplied to the stacked structure 5 through the air flow path 2a reaches the cathode electrode 5c through the gas diffusion layer 5e. Then, oxygen contained in the air which has been supplied to the cathode electrode 5c reacts with both protons and electrons transferred from the anode electrode 5b in the cathode electrode 5c to produce water. The reaction in the cathode electrode 5c to produce water is expressed by the following formula (2).

O₂+4H⁺+4e⁻→2H₂O (2)

As shown in FIGS. 1 and 2, the fuel cell module 100 comprises: the separator 1 having the deep grooves 1x, 1y; and the separator 4 having the deep grooves 4x, 4y. The deep grooves 1x, 1y and the deep grooves 4x, 4y can be formed by a known method such as press forming, drawing, and resin molding. In other words, with thinning of the unit cell, even when the thickness of the separator is made thinner, the deep groove in the fuel cell module of the invention can be easily formed. By securing the deep groove, even when the unit cell is made thinner, it is possible to secure an adequate sealing function (sealing property) by using not only gasket and adhesive but also inexpensive and easily exchangeable O-ring. Accordingly, with the present invention, even when the unit cell is made thinner, it is possible to provide the fuel cell module 100 which is capable of easily securing an adequate sealing function.

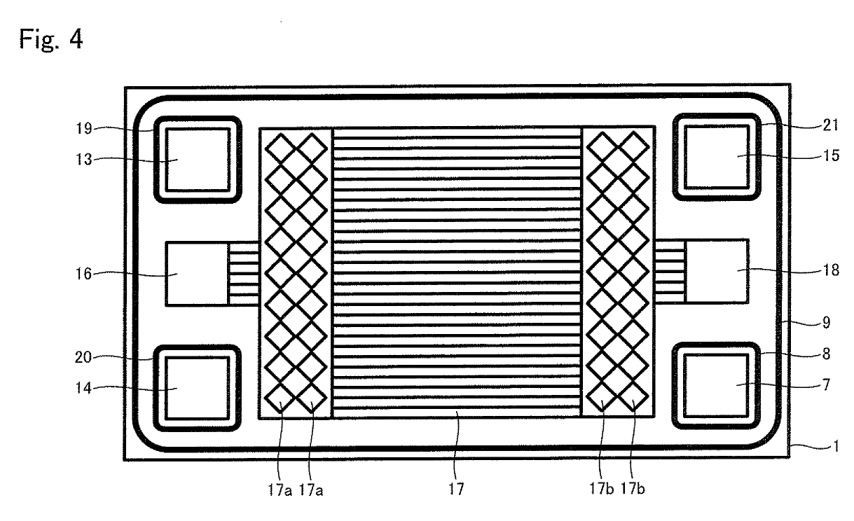

FIG. 4 is a top view of the separator 1. As shown in FIG. 4, the separator 1 comprises: holes 7, 13 of the hydrogen manifold; holes 14, 15 of the air manifold; and holes 16, 18 of the cooling medium manifold. The holes 16 and 18 are connected to each other through a linear cooling medium passages 17 formed in the upper face of the separator 1. In the separator 1, a plurality of protrusions 17a, 17a, . . . are provided between the hole 16 and the cooling medium passage 17, and a plurality of protrusions 17b, 17b, . . . are provided between the cooling medium passage 17 and the hole 18. As shown in FIG. 4, the O-ring 8 is disposed around the hole 7, the O-ring 19 is disposed around the hole 13, the O-ring 20 is disposed around the hole 14, and the O-ring 21 is disposed around the hole 15. Then, the O-ring 9 is disposed at the outer periphery of the separator 1 in a manner to encircle these O-rings. With such a configuration, it is possible to prevent leakage of hydrogen gas by the O-rings 8, 19; it is possible to prevent leakage of the air by the O-rings 20, 21; and it is possible to prevent leakage of the cooling medium by the O-ring 9.

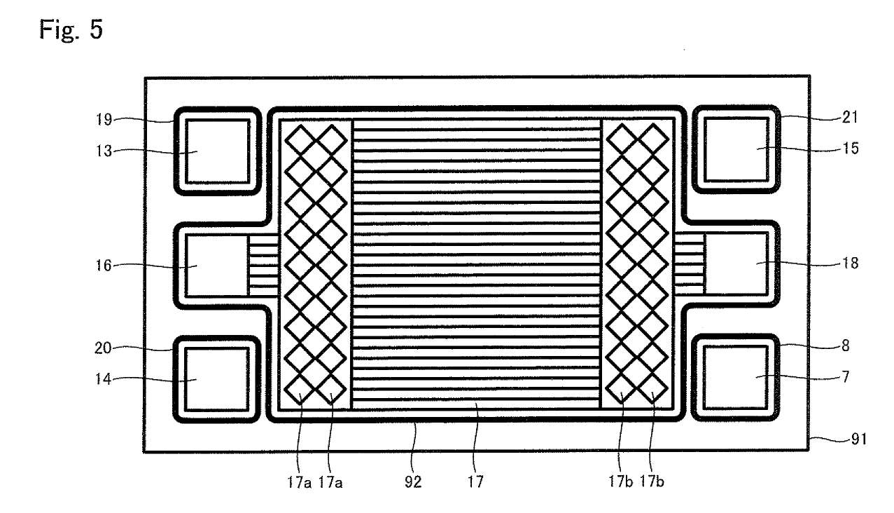

FIG. 5 is a plan illustrating a mode of conventional sealing. In FIG. 5, to the elements having the same structure as those in the separator 1, the same reference numerals as those used in FIG. 4 are given and the explanation thereof is omitted. As shown in FIG. 5, in a conventional separator 91, when sealing the cooling medium passing through the hole 16, the cooling medium passage 17, and the hole 18, a sealing member 92 is disposed along the outer periphery of the hole 16, the cooling medium passage 17, and the hole 18. By disposing the sealing member 92 in this way, it is possible to make the area surrounded by the sealing member 92 smaller. However, the sealing member 92 shown in FIG. 5 has more complicated shape than the sealing member 9 shown in FIG. 4. So, when an O-ring is set in the groove having a complicated shape, the O-ring is twisted; thereby it is difficult to secure an adequate sealing function. Thus, it is difficult to use O-ring as the sealing member 92. Even when the shape of grooves is complicated, sealing member such as gasket and adhesive can be used; so, conventionally, gasket and adhesive have been used as the sealing member 92. However, when taking out one of the stacked bodies 10 which needs a replacement from a plurality of the stacked bodies 10, 10, . . . which are laminated (shown in FIG. 2), if an adhesive is used as the sealing member 92, it is difficult to replace only the adhesive. Therefore, it is necessary to replace a plurality of the stacked bodies 10, 10, . . . as a whole adhered by adhesive, which may raise the replacement cost. Other than this, it is difficult to inject and cure the adhesive after laminating a plurality of the stacked bodies 10, 10, . . . . On the other hand, when using a gasket as the sealing member 92, since the gasket can be replaceable, it is possible to replace, with a new gasket, a gasket broken at a time when taking out the stacked body 10. However, gasket is more expensive than O-ring; so even when using gasket as the sealing member 92, the replacement cost tends to be higher compared with the case of using O-ring.

On the other hand, as shown in FIG. 4, in the separator 1, the O-ring 9 is arranged in the outer periphery of the separator 1 in a manner to encircle the O-ring 19, the hole 16, the O-ring 20, the cooling medium passage 17, the O-ring 8, the hole 18, and O-ring 21. By arranging the O-ring 9 in such a position, the shape can be simplified than that of the sealing member 92 and it is possible to prevent twist of the O-ring 9. Therefore, even when using the O-ring 9, it is possible to secure an adequate sealing function. The O-ring 9 is more replaceable and inexpensive than gasket. So, compared with the case of using adhesive and gasket as the sealing member, it is possible to reduce the cost for replacing one of the stacked bodies 10 and reassembling the fuel cell module 100. In addition, the O-ring 9 can be easily detached than gasket; so, it improves the efficiency of the replacement. Further, since O-ring does not have protrusions such as the ones which gasket has, it is possible to make the surface of the laminated stacked body smooth; thereby possible to improve the efficiency of the replacement.

In the above description, an embodiment in which the O-rings 8, 9, 19, 20, 21 are used as the sealing member is shown; the invention is not limited to this embodiment. In the fuel cell module of the invention, a sealing member other than O-ring (for example, adhesive and gasket) may be used. It should be noted that to have a configuration which is capable of easily securing an adequate sealing function with reduction of the cost of replacing the stacked body and improvement of the work efficiency, O-ring is preferably used as the sealing member.

Moreover, in the above description, as shown in FIGS. 1 and 2, embodiments comprise: a separator 1 having the deep grooves 1x, 1y of which depth is larger than the thickness of the separator 1 opposing to the stacked structure 5 in the stacking direction of the stacked body 10; and a separator 4 having the deep grooves 4x, 4y of which depth is larger than the thickness of the separator 4 at a position opposing to the stacked structure 5 in the stacking direction of the stacked body 10. However, the invention is not limited to this embodiment. The fuel cell module of the invention may have a configuration where a separator having the deep grooves is provided at only one end of the stacked body in the stacking direction, while a separator without having the deep groove is provided at the other end of the stacked body.

In addition, in the above description, as shown in FIGS. 1 and 2, embodiments comprise the separator 1 where the height of protrusion formed in the face which does not have the deep grooves 1x, 1y is larger than the thickness of the stacked structure 5. However, the invention is not limited to this embodiment. The fuel cell module of the invention may be provided with a separator (which has the deep grooves and where the height of the protrusion is larger than the thickness of the stacked structure) each on both ends of the stacked body; it may also have a configuration where the separator (which has the deep grooves and where the height of the protrusion is larger than the thickness of the stacked structure) is not provided to the stacked body.

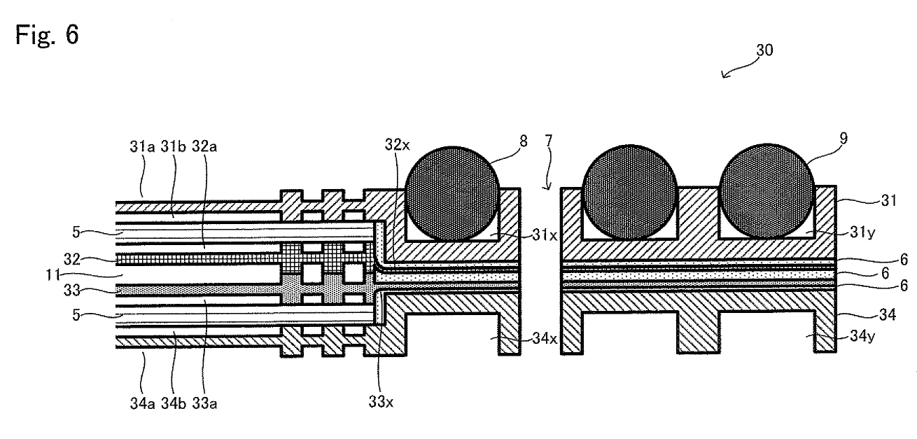

Further, in the above description, as shown in FIGS. 1 and 2, the embodiments has a configuration where the separator 1 and the separator 2 are arranged so that the outer periphery of the separator 1 locates in the periphery of the separator 2 of which area of a face whose normal direction is the stacking direction is smaller than the separator 1; and the deep grooves 1x, 1y locate in the periphery of the separator 2. However, the invention is not limited to this embodiment. When a separator where the height of the protrusion formed in the back-face side of the separator having the deep groove is larger than the thickness of the stacked structure is provided to the fuel cell module of the present invention, the height of the protrusion may be absorbed by modifying the shape in the thickness direction of the separator without having the deep groove, instead of being absorbed by reducing the size of the area of the separator 2 like the one in the fuel cell module 100. An embodiment of the stacked body in which the height of the protrusion is absorbed by modifying the shape thereof in the thickness direction of the separator which does not have a deep groove is shown in FIG. 6.

FIG. 6 is a cross-sectional view illustrating a stacked body 30. FIG. 6 shows a cross-section of a part of the stacked body 30. In FIG. 6, a hydrogen gas inlet passage connecting the hydrogen manifold 7 to hydrogen gas flow paths 31b, 33a, an air inlet passage connecting the air manifold (not shown) to the air flow paths 32a, 34b, and a cooling medium inlet passage connecting the cooling medium manifold (not shown) to cooling medium passages 31a, 34a, 11, are not shown. In FIG. 6, to the elements having the same structure as those in the fuel cell module 100, the same reference numerals as those used in FIG. 1 are given and the explanation thereof is omitted. As shown in FIG. 6, the stacked body 30 comprises: stacked structures 5, 5; separators 31, 32, 33, 34 arranged to sandwich the stacked structures 5, 5; a hole 7 which functions as a hydrogen manifold; an air manifold (not shown); and a cooling medium manifold. The stacked body 30 is provided with the separator 31 on one end and the separator 34 on the other end in the stacking direction (i.e. vertical direction of FIG. 6.). Adhesives 6, 6, 6 are arranged in the outer periphery of the stacked structures 5, 5; by using the adhesives 6, 6, 6, the outer periphery of the separators 31, 32, 33, 34 are fixed. The separator 31 has deep grooves 31x, 31y, which are capable of receiving O-rings 8, 9, as a sealing member in a face which does not oppose to the stacked structure 5; while, the separator 34 has deep grooves 34x, 34y which are capable of receiving O-rings 8, 9, as a sealing member in a face which does not oppose to the stacked structure 5. The deep grooves 31x, 31y and the deep grooves 34x, 34y can be formed by a known method such as press forming, drawing, and resin molding.

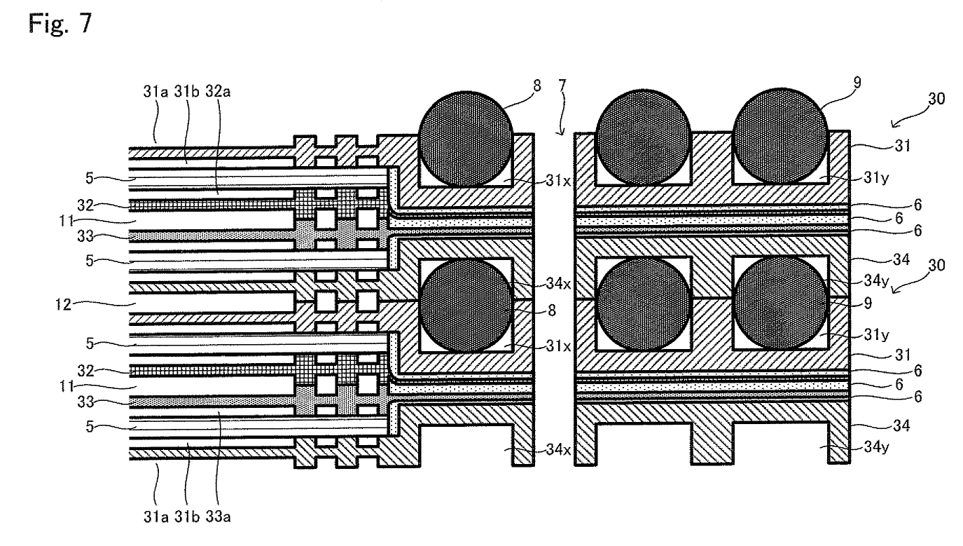

FIG. 7 is a cross-sectional view illustrating a state where a plurality of the stacked bodies 30, 30 are laminated. In FIG. 7, a hydrogen gas inlet passage connecting the hydrogen manifold 7 to the hydrogen gas flow paths 31b, 33a, an air inlet passage connecting the air manifold (not shown) to the air flow paths 32a, 34b, and a cooling medium inlet passage connecting the cooling medium manifold (not shown) to the cooling medium passages 31a, 34a, 11, 12, are not shown. In FIG. 7, to the elements having the same structure as those in the fuel cell module 100, the same reference numerals as those used in FIG. 2 are given and the explanation thereof is omitted. As shown in FIG. 7, when a plurality of the stacked bodies 30, 30 are laminated, the O-ring 8 is set in a space defined by the deep groove 31x and the deep groove 34x and the O-ring 9 is set in a space defined by the deep groove 31y and the deep groove 34y. To secure a predetermined sealing property, the total depth of the deep groove 31x and the deep groove 34x is smaller than the diameter of the O-ring 8; with the O-ring 8 thus arranged, it is possible to prevent leakage of hydrogen passing through the hydrogen manifold 7. To secure a predetermined sealing property, the total depth of the deep groove 31y and the deep groove 34y is smaller than the diameter of the O-ring 9; with the O-ring 9 thus arranged, it is possible to prevent leakage of the cooling medium passing through the cooling medium passage 12.

As shown in FIG. 6, the separator 32 which does not have the deep groove absorbs a part of the height of the protrusion formed in the back-face side of the deep grooves 31x, 31y (i.e. the lower side of FIG. 6.) by modifying the shape of the separator 32 in the thickness direction (i.e. the vertical direction of FIG. 6.) and forming the recess portion 32x in the top-face side of the separator 32 (i.e. the upper side of FIG. 6.). The separator 33 which does not have the deep groove absorbs a part of the height of the protrusion formed in the back-face side of the deep grooves 34x, 34y (i.e. the upper side of FIG. 6.) by modifying the shape of the separator 33 in the thickness direction (i.e. the vertical direction of FIG. 6.) and forming the recess portion 33x in the underside of the separator 33 (i.e. the lower side of FIG. 6.). Even by the stacked body 30 with this configuration, it is possible to secure the deep grooves 31x, 31y and the deep grooves 34x, 34y. Therefore, in the same manner as the stacked body 10, even when the thickness of the separator is made thinner, it is possible to secure the sealing function (sealing property) by not only using gasket and adhesive but also using inexpensive and easily replaceable O-rings 8, 9. Accordingly, by the present invention with the stacked body 30, it is possible to provide a fuel cell module which is capable of easily securing an adequate sealing function even when the unit cell is made thinner.

As shown in FIGS. 1, 2, 5, and 7, the above description regarding the invention shows embodiments in which depth of respective separators is all the same. However, the fuel cell module of the present invention is not limited to these embodiments. The fuel cell module of the invention may have an embodiment which comprises a separator having a plurality of grooves of which depth is respectively different. So, the embodiment which comprises a separator having a plurality of grooves of which depth is respectively different will be described as follows.

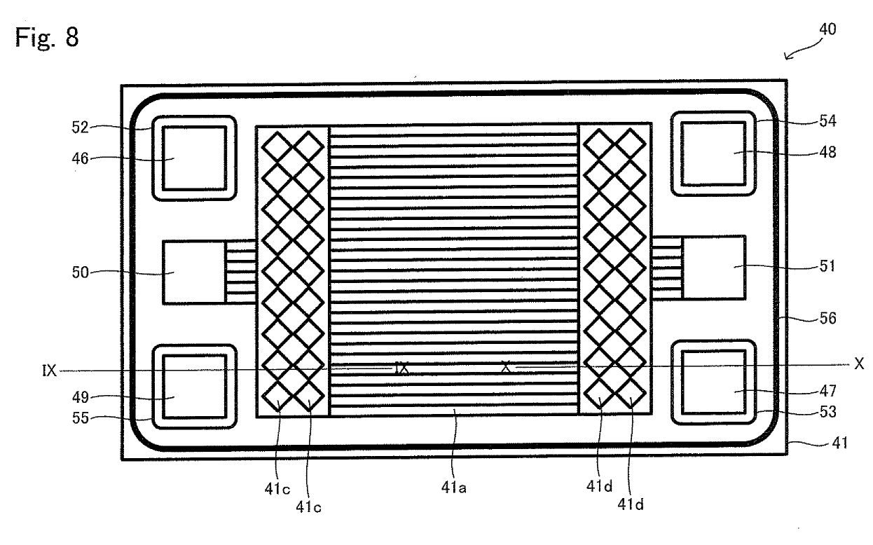

FIG. 8 is a top view of a separator 40 provided to the fuel cell module of the invention. As shown in FIG. 8, a separator 41 is provided in one end of the stacked body 40 in the stacking direction. The separator 41 comprises: holes 46, 47 of the hydrogen manifold; holes 48, 49 of the air manifold; and holes 50, 51 of cooling medium manifold. The holes 50 and 51 are connected to each other through a linear cooling medium passage 41a formed in the surface of the separator 41. In the separator 41, a plurality of protrusions 41c, 41c, . . . are provided between the hole 50 and the cooling medium passage 41a, and a plurality of protrusions 41d, 41d, . . . are provided between the cooling medium passage 41a and the hole 51. As shown in FIG. 8, an O-ring 52 is disposed around the hole 46, an O-ring 53 is disposed around the hole 47, an O-ring 54 is disposed around the hole 48, and an O-ring 55 is disposed around the hole 49. Then, an O-ring 56 of which diameter is larger than the O-rings 52, 53, 54, 55 is disposed in the outer periphery of the separator 41 in a manner to encircle these O-rings. With such a configuration, it is possible to prevent leakage of hydrogen gas by the O-rings 52, 53; it is possible to prevent leakage of air by the O-rings 54, 55; and it is possible to prevent leakage of the cooling medium by the O-ring 56.

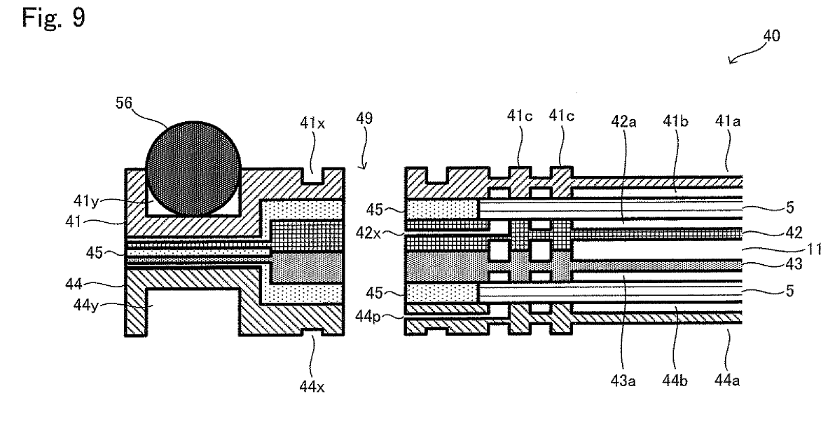

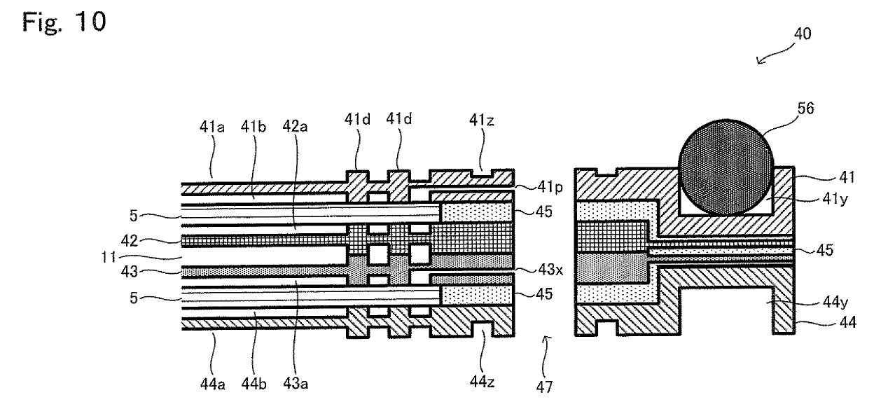

FIG. 9 is a view enlarging the cross section taken along the line IX-IX of FIG. 8. To make seeing of the groove 41x easier, FIG. 9 does not show the O-ring 55 provided to the groove 41x. FIG. 10 is a view enlarging the cross section taken along the line X-X of FIG. 8. To make seeing of the groove 41z easier, FIG. 10 does not show the O-ring 53 provided to the groove 41z. As shown in FIGS. 9 and 10, the stacked body 40 comprises: the stacked structures 5, 5; the separators 41, 42, 43, 44 provided to sandwich the stacked structures 5, 5; the hole 47 which functions as a hydrogen manifold; and the hole 49 which functions as an air manifold. In the stacked body 40, the separator 41 is provided in one end and the separator 44 is provided in the other end thereof in the stacking direction (i.e. the vertical direction of FIGS. 9 and 10.). Adhesives 45, 45, 45 are arranged in the outer periphery of the stacked structures 5, 5; by using the adhesives 45, 45, 45, the outer periphery of the separators 41, 42, 43, 44 are fixed. The separator 41 has: the deep groove 41y to which the O-ring 56 is set, the groove 41x to which the O-ring 55 is set, and the groove 41z to which the O-ring 53 is set, respectively in a face which does not oppose to the stacked structure 5, while the separator 44 has: the cooling medium passage 44a, the deep groove 44y which is capable of receiving the O-ring 56, the groove 44x which is capable of receiving the O-ring 55, and the groove 44z which is capable of receiving the O-ring 53, respectively in a face which does not oppose to the stacked structure 5. The grooves 41x, 41z, 44x, 44z and the deep grooves 41y, 44y can be formed by a known method such as press forming, drawing, and resin molding.

As shown in FIG. 10, the separator 41 is provided with a fluid inlet passage 41p (hereinafter, referred to as “hydrogen inlet passage 41p”.) which connects the hole 47 to the hydrogen gas flow path 41b; while the separator 43 is provided with a fluid inlet passage 43x which connects the hole 47 to the hydrogen gas flow path 43a. In addition, as shown in FIG. 9, the separator 42 is provided with a fluid inlet passage 42x which connects the hole 49 to the air flow path 42a; while the separator 44 is provided with a fluid inlet passage 44p (hereinafter, referred to as “air inlet passage 44p”.) which connects the hole 49 to the air flow path 44b. As shown in FIGS. 9 and 10, the depth of the groove 41z provided in a manner to stride across the hydrogen inlet passage 41p is smaller than the depth of the groove 41x which does not stride across the fluid inlet passage; the depth of the groove 44x provided in a manner to stride across the air inlet passage 44p is smaller than the depth of the groove 44z which does not stride across the fluid inlet passage. By setting the depth of the grooves 41x, 41z, 44x, 44z in this way, thinning of the unit cell tends to be easily attained while securing an adequate sealing function. It should be noted that since the stacked body 40 has the deep grooves 41y, 44y, with the fuel cell module of the invention having the stacked body 40, it is possible to easily secure an adequate sealing function even when the unit cell is made thinner.

The above description regarding the present invention shows an embodiment where, for example, the cooling medium passages 1a, 4a and the deep grooves 1y, 4y to which the O-ring 9 is to be set for preventing outflow of the cooling medium passing in the cooling medium passages 1a, 4a are provided in a face (which does not oppose to the stacked structures 5, 5) of the separators 1, 4 provided at the ends of the stacked body 10 in the stacking direction. However, the invention is not limited to the embodiment. The fuel cell module of the invention may have an embodiment in which a passage for making the air pass through and a groove which is to be provided with a sealing member for preventing outflow of air passing through the passage are provided, in a face (which does not oppose to the stacked structure) of the separator provided at the ends of the stacked body in the stacking direction. Other than this, the fuel cell module of the invention may have an embodiment in which a passage for making fluid pass through and a groove which is to be provided with a sealing member corresponding to the passage for making fluid pass through are not provided, in a face (which does not oppose to the stacked structure) of the separator provided to the ends of the stacked body in the stacking direction. It should be noted that in view of obtaining a configuration which is capable of thinning and attaining higher performance by reduction of wasted space of the fuel cell module, the fuel cell module preferably has a configuration comprising a passage for making the cooling medium or air pass through and grooves for setting a sealing member for preventing outflow of the cooling medium or air passing through the passage, in a face (which does not oppose to the stacked structure) of the separator provided at the end of the stacked body in the stacking direction. Moreover, so as to provide an inexpensive fuel cell module in which the sealing member can be easily replaced, the groove for the sealing member provided in a face which does not oppose to the stacked structure is preferably provided in the outer periphery of the separator disposed at the end of the stacked body in the stacking direction. To the groove, an O-ring is preferably provided.

Further, the above description shows an embodiment in which sealing member for preventing outflow of the cooling medium or air passing through the passage is provided in a face which does not oppose to the stacked structure when providing a passage for cooling medium or air in a face (which does not oppose to the stacked structure) of the separator disposed at the end of the stacked body in the stacking direction. However, the invention is not limited to the embodiment. The fuel cell module of the invention may also have a configuration where the sealing member for preventing outflow of the cooling medium or air passing through the passage is not provided in a face which does not oppose to the stacked structure even when providing the passage for cooling medium or air in a face (which does not oppose to the stacked structure) of the separator provided at the end of the stacked body in the stacking direction. In such a case, it maybe thought that the cooling medium or air flows out from the stacked body; however, as described above, since the fuel cell module of the invention is used in a state where the stacked body is housed in a case, it is assumed that there is no influence to the external environment as long as the cooling medium or air does not flow out from the case. Because of this, when the sealing member for preventing outflow of the cooling medium or air passing in the face (which does not oppose to the stacked structure) of the separator disposed at the end of the stacked body in the stacking direction is not disposed in a face which does not oppose to the stacked structure, sealing function for preventing outflow of the cooling medium or air may be given to the case receiving the stacked body. For example, let us study a case that a laminated plurality of the stacked bodies are received in a case by making a laminated plurality of the stacked bodies received in a rectangular first case, whose one of the faces is opened and covering the opening with a sheet member. In this case, for example, when providing liquid packing, O-ring, and so on, in a face which opposes to the stacked body of a sheet member, by covering with the sheet member the opening of the first case which receives the plurality of the stacked body, it is possible to give the sealing function for preventing outflow of the cooling medium or air to the case for receiving the stacked body. By handing over the sealing function to the case which receives the stacked body, there is no need for providing a sealing member for preventing outflow of the cooling medium or air passing through the passage provided in the face (which does not oppose to the stacked structure) of the separator provided at the end of the stacked body in the stacking direction to the face which does not oppose to the stacked structure; so, it is possible to provide a fuel cell module which is capable of simplifying the production process.

### DESCRIPTION OF THE REFERENCE NUMERALS

1, 2, 3, 4 separator

1a, 4a, 11, 12, 17 cooling medium passage

1b, 3a hydrogen gas flow path

1x, 1y, 4x, 4y deep groove

2a, 4b air flow path

5 stacked structure

6 adhesive

7, 13 hole (hydrogen manifold)

8, 9, 19, 20, 21 O-ring (sealing member)

10 stacked body

14, 15 hole (air manifold)

16, 18 hole (cooling medium manifold)

30 stacked body

31, 32, 33, 34 separator

31a, 34a cooling medium passage

31b, 33a hydrogen gas flow path

31x, 31y, 34x, 34y deep groove

32a, 34b air flow path

32x, 33x recess portion

40 stacked body

41, 42, 43, 44 separator

41a cooling medium passage

41b, 43a hydrogen gas flow path

41p hydrogen inlet passage (fluid inlet passage)

41x, 41z groove

41y deep groove

42a, 44b air flow path

42x, 43x fluid inlet passage

44a cooling medium passage

44p air inlet passage (fluid inlet passage)

44x, 44z groove

44y deep groove

45 adhesive

46, 47 hole (hydrogen manifold)

48, 49 hole (air manifold)

50, 51 hole (cooling medium manifold)

52, 53, 54, 55, 56 O-ring (sealing member)

100 fuel cell module

1-6. (canceled)

7. A fuel cell module comprising a stacked body which comprises: a stacked structure including: an electrolyte layer, and a pair of electrodes provided to sandwich the electrolyte layer; and a pair of separators disposed to sandwich the stacked structure,
the separators being arranged at least one end of the stacked body in the stacking direction,
the separators which are arranged at the end of the stacked body having a groove which is capable of receiving a sealing member in a face which does not oppose to the stacked structure, and
the at least one groove being a deep groove of which depth is larger than the thickness of the separator having the groove.

8. The fuel cell module according to claim 7, wherein the height of a protrusion formed in a face, which does not have the deep groove, of the separator having the deep groove is larger than the thickness of the stacked structure contacting the separator.

9. The fuel cell module according to claim 8, wherein at least one of the separators which does not have the deep groove has a recess portion which is capable of absorbing at least a part of the height of the protrusion.

10. The fuel cell module according to claim 7, wherein the area of a face, of which normal direction is the stacking direction, of at least one of the separators which do not have the deep groove is smaller than the separator having the deep groove,
the smaller-sized separator and the separator having the deep groove are arranged so that the outer periphery of the separator having the deep groove locates in the periphery of the smaller-sized separator, and
the deep groove is provided in the outer periphery of the separator having the deep groove located in the periphery of the smaller-sized separator.

11. The fuel cell module according to claim 8, wherein the area of a face, of which normal direction is the stacking direction, of at least one of the separators which do not have the deep groove is smaller than the separator having the deep groove,
the smaller-sized separator and the separator having the deep groove are arranged so that the outer periphery of the separator having the deep groove locates in the periphery of the smaller-sized separator, and
the deep groove is provided in the outer periphery of the separator having the deep groove located in the periphery of the smaller-sized separator.

12. The fuel cell module according to claim 9, wherein the area of a face, of which normal direction is the stacking direction, of at least one of the separators which do not have the deep groove is smaller than the separator having the deep groove,
the smaller-sized separator and the separator having the deep groove are arranged so that the outer periphery of the separator having the deep groove locates in the periphery of the smaller-sized separator, and
the deep groove is provided in the outer periphery of the separator having the deep groove located in the periphery of the smaller-sized separator.

13. The fuel cell module according to claim 7, wherein the separator having the deep groove has a fluid inlet passage penetrating therein, and
the groove provided at the position having the fluid inlet passage is shallower than at least one of the grooves provided at the position which does not have the fluid inlet passage.

14. The fuel cell module according to claim 8, wherein the separator having the deep groove has a fluid inlet passage penetrating therein, and
the groove provided at the position having the fluid inlet passage is shallower than at least one of the grooves provided at the position which does not have the fluid inlet passage.

15. The fuel cell module according to claim 9, wherein the separator having the deep groove has a fluid inlet passage penetrating therein, and
the groove provided at the position having the fluid inlet passage is shallower than at least one of the grooves provided at the position which does not have the fluid inlet passage.

16. The fuel cell module according to claim 10, wherein the separator having the deep groove has a fluid inlet passage penetrating therein, and
the groove provided at the position having the fluid inlet passage is shallower than at least one of the grooves provided at the position which does not have the fluid inlet passage.

17. The fuel cell module according to claim 11, wherein the separator having the deep groove has a fluid inlet passage penetrating therein, and
the groove provided at the position having the fluid inlet passage is shallower than at least one of the grooves provided at the position which does not have the fluid inlet passage.

18. The fuel cell module according to claim 12, wherein the separator having the deep groove has a fluid inlet passage penetrating therein, and
the groove provided at the position having the fluid inlet passage is shallower than at least one of the grooves provided at the position which does not have the fluid inlet passage.

19. The fuel cell module according to claim 7, wherein a face, which does not oppose to the stacked structure, of the separator arranged at an end of the stacked body in the stacking direction comprises a passage for making a cooling medium or an oxygen-containing gas pass through and a groove which is capable of receiving a sealing member for preventing outflow of a cooling medium or an oxygen-containing gas passing through the passage, and
the groove is provided in the outer periphery of the separator so that the groove encircles the passage, the manifold for the air to be supplied to the stacked structure, and the manifold for the cooling medium.

20. The fuel cell module according to claim 8, wherein a face, which does not oppose to the stacked structure, of the separator arranged at an end of the stacked body in the stacking direction comprises a passage for making a cooling medium or an oxygen-containing gas pass through and a groove which is capable of receiving a sealing member for preventing outflow of a cooling medium or an oxygen-containing gas passing through the passage, and
the groove is provided in the outer periphery of the separator so that the groove encircles the passage, the manifold for the air to be supplied to the stacked structure, and the manifold for the cooling medium.

21. The fuel cell module according to claim 9, wherein a face, which does not oppose to the stacked structure, of the separator arranged at an end of the stacked body in the stacking direction comprises a passage for making a cooling medium or an oxygen-containing gas pass through and a groove which is capable of receiving a sealing member for preventing outflow of a cooling medium or an oxygen-containing gas passing through the passage, and
the groove is provided in the outer periphery of the separator so that the groove encircles the passage, the manifold for the air to be supplied to the stacked structure, and the manifold for the cooling medium.

22. The fuel cell module according to claim 10, wherein a face, which does not oppose to the stacked structure, of the separator arranged at an end of the stacked body in the stacking direction comprises a passage for making a cooling medium or an oxygen-containing gas pass through and a groove which is capable of receiving a sealing member for preventing outflow of a cooling medium or an oxygen-containing gas passing through the passage, and
the groove is provided in the outer periphery of the separator so that the groove encircles the passage, the manifold for the air to be supplied to the stacked structure, and the manifold for the cooling medium.

23. The fuel cell module according to claim 11, wherein a face, which does not oppose to the stacked structure, of the separator arranged at an end of the stacked body in the stacking direction comprises a passage for making a cooling medium or an oxygen-containing gas pass through and a groove which is capable of receiving a sealing member for preventing outflow of a cooling medium or an oxygen-containing gas passing through the passage, and
the groove is provided in the outer periphery of the separator so that the groove encircles the passage, the manifold for the air to be supplied to the stacked structure, and the manifold for the cooling medium.

24. The fuel cell module according to claim 12, wherein a face, which does not oppose to the stacked structure, of the separator arranged at an end of the stacked body in the stacking direction comprises a passage for making a cooling medium or an oxygen-containing gas pass through and a groove which is capable of receiving a sealing member for preventing outflow of a cooling medium or an oxygen-containing gas passing through the passage, and
the groove is provided in the outer periphery of the separator so that the groove encircles the passage, the manifold for the air to be supplied to the stacked structure, and the manifold for the cooling medium.

25. The fuel cell module according to claim 13, wherein a face, which does not oppose to the stacked structure, of the separator arranged at an end of the stacked body in the stacking direction comprises a passage for making a cooling medium or an oxygen-containing gas pass through and a groove which is capable of receiving a sealing member for preventing outflow of a cooling medium or an oxygen-containing gas passing through the passage, and
the groove is provided in the outer periphery of the separator so that the groove encircles the passage, the manifold for the air to be supplied to the stacked structure, and the manifold for the cooling medium.

26. The fuel cell module according to claim 14, wherein a face, which does not oppose to the stacked structure, of the separator arranged at an end of the stacked body in the stacking direction comprises a passage for making a cooling medium or an oxygen-containing gas pass through and a groove which is capable of receiving a sealing member for preventing outflow of a cooling medium or an oxygen-containing gas passing through the passage, and
the groove is provided in the outer periphery of the separator so that the groove encircles the passage, the manifold for the air to be supplied to the stacked structure, and the manifold for the cooling medium.

27. The fuel cell module according to claim 15, wherein a face, which does not oppose to the stacked structure, of the separator arranged at an end of the stacked body in the stacking direction comprises a passage for making a cooling medium or an oxygen-containing gas pass through and a groove which is capable of receiving a sealing member for preventing outflow of a cooling medium or an oxygen-containing gas passing through the passage, and
the groove is provided in the outer periphery of the separator so that the groove encircles the passage, the manifold for the air to be supplied to the stacked structure, and the manifold for the cooling medium.

28. The fuel cell module according to claim 16, wherein a face, which does not oppose to the stacked structure, of the separator arranged at an end of the stacked body in the stacking direction comprises a passage for making a cooling medium or an oxygen-containing gas pass through and a groove which is capable of receiving a sealing member for preventing outflow of a cooling medium or an oxygen-containing gas passing through the passage, and
the groove is provided in the outer periphery of the separator so that the groove encircles the passage, the manifold for the air to be supplied to the stacked structure, and the manifold for the cooling medium.

29. The fuel cell module according to claim 17, wherein a face, which does not oppose to the stacked structure, of the separator arranged at an end of the stacked body in the stacking direction comprises a passage for making a cooling medium or an oxygen-containing gas pass through and a groove which is capable of receiving a sealing member for preventing outflow of a cooling medium or an oxygen-containing gas passing through the passage, and
the groove is provided in the outer periphery of the separator so that the groove encircles the passage, the manifold for the air to be supplied to the stacked structure, and the manifold for the cooling medium.

30. The fuel cell module according to claim 18, wherein a face, which does not oppose to the stacked structure, of the separator arranged at an end of the stacked body in the stacking direction comprises a passage for making a cooling medium or an oxygen-containing gas pass through and a groove which is capable of receiving a sealing member for preventing outflow of a cooling medium or an oxygen-containing gas passing through the passage, and
the groove is provided in the outer periphery of the separator so that the groove encircles the passage, the manifold for the air to be supplied to the stacked structure, and the manifold for the cooling medium.
